(19) United States
(12) Patent Application Publication
(10) Pub. No.: US 2019/0102393 A1
(43) Pub. Date: Apr. 4, 2019

(54) RANKING CONTACT ENTRIES

(71) Applicant: Google Inc., Mountain View, CA (US)

(72) Inventors: Bryan Christopher Horling, Sunnyvale, CA (US); Okan Kolak, Sunnyvale, CA (US); Rosa Wu, San Francisco, CA (US)

(21) Appl. No.: 14/296,289

(22) Filed: Jun. 4, 2014

(51) Int. Cl. G06F 17/30

(52) U.S. Cl. CPC G06F 17/3053

(57) ABSTRACT

Methods and apparatus for ranking contact entries. Some implementations are directed generally to ranking a contact entry of a user relative to one or more additional information items and providing information related to the contact entry and/or the additional information items based on the ranking. For example, a contact entry of a user may be identified based on a query and a score determined for the contact entry. An additional information item may also be identified based on the query and a score determined for the additional information item. The contact entry and the additional information item may be ranked based on their scores and information related to the contact entry and/or the additional information item may be provided based on the ranking.

### BACKGROUND

A user may be associated with one or more contacts collections, each including one or more contact entries. For example, a user may have a contacts collection on a mobile phone that includes contact entries each including one or more properties of an entity such as a name, phone number, and/or email address of the entity. Also, for example, the user may have a contacts collection associated with an e-mail service that includes contact entries each including one or more properties of an entity.

### SUMMARY

This specification is directed generally to ranking contact entries, and, more particularly, to ranking a contact entry of a user relative to one or more additional information items and providing information related to the contact entry and/or the additional information items based on the ranking. For example, a contact entry of a user may be identified based on a query and a score determined for the contact entry. An additional information item may be identified based on the query such as another contact entry, a publicly accessible document, and/or another non-contact entry information item associated with the user. A score may also be determined for the additional information item. The contact entry and the additional information item may be ranked based on their scores and information related to the contact entry and/or the additional information item may be provided based on the ranking. For example, only the highest ranked of the contact entry and the additional information item may be provided or both may be provided and the highest ranked of the contact entry and the additional information item may be indicated for more prominent presentation.

In some implementations, the additional information item may be identified from a source that is distinct from the source from which the contact entry was identified. For example, the contact entry may be identified from a contacts collection of the user and the additional information item may be a publicly accessible document identified from an index that includes publicly accessible documents such as documents accessible via the World Wide Web.

In some implementations, the additional information item is an additional contact entry. In some versions of those implementations, the contact entry and the additional contact entry are ranked relative to one another (and optionally other information item(s)) based on temporal data and/or other signals associated with the contact entry and/or the additional contact entry. The temporal data of a contact entry may include one or more times and/or one or more dates associated with the contact entry that indicate time(s) and/or date(s) during which the user has interacted with the entity of the contact entry. For example, the ranking of a given contact entry may be promoted if the given contact entry is associated with temporal data that matches or is near a time and/or date of submission of the query. In some implementations, the temporal data of a contact entry may indicate a type of contact associated with one or more of the times and/or dates that indicates the manner by which the user has interacted with the contact entry (e.g., “calling”, “texting”, “emailing”). In some versions of those implementations, the ranking of the contact entry may further be based on the indicated type of contact. For example, the ranking of a given contact entry may be promoted if the given contact entry is associated with temporal data that matches or is near a time and/or date of submission of the query—and if the temporal data is associated with a contact type that matches a contact type indicated by the query.

In some implementations, a computer implemented method may be provided that includes the steps of: identifying a query of a user; identifying, from a contacts collection personal to the user, a contact entry of the contacts collection based on one or more relationships between the query and the contact entry; determining a contact entry score for the contact entry based at least in part on the one or more relationships between the query and the contact entry; identifying, from a source distinct from the contacts collection, at least one additional information item based on one or more relationships between the query and the additional information item; determining an additional information item score for the additional information item based at least in part on the one or more relationships between the query and the additional information item; ranking the contact entry and the additional information item based on the contact entry score and the additional information item score; and providing, based on the ranking and responsive to the query, information related to at least one of: the contact entry and the additional information item.

This method and other implementations of technology disclosed herein may each optionally include one or more of the following features.

In some implementations, the source distinct from the contacts collection is an index of publicly accessible information items. In some of those implementations, the method further includes determining the contact entry score fails to satisfy a threshold, wherein identifying the at least one additional information item occurs in response to the contact entry score failing to satisfy a threshold.

In some implementations determining the contact entry score includes determining the contact entry score based on an affinity measure associated with the contacts collection. In some of those implementations, the source distinct from the contacts collection is a second contacts collection and determining the additional information score includes determining the additional information score based on a second affinity measure associated with the second contacts collection.

In some implementations, determining the contact entry score for the contact entry based at least in part on the one or more relationships between the query and the contact entry includes: identifying a matching relationship between a term of the query and a node of the contact entry and determining the contact entry score based on a node type of the node.

In some implementations, the method further includes identifying a contact indication measure of the query and determining the contact entry score for the contact entry is further based on the contact indication measure. In some of those implementations, the contact indication measure of the query is based at least in part on one or more terms of the query.

In some implementations, determining the contact entry score for the contact entry based at least in part on the one or more relationships between the query and the contact entry includes identifying a lack of matching between a term of the query and the contact entry, wherein the contact entry score is based on a type of the term of the query.

In some implementations, determining the contact entry score for the contact entry based at least in part on the one or more relationships between the query and the contact entry includes: identifying one or more of a date and a time associated with a submission of the query; and determining the contact entry score based on an association between the one or more of the date and time and the contact entry.

In some implementations, ranking the contact entry and the additional information item based on the contact entry score and the additional information item score includes selecting one of the contact entry and the additional information item based on the ranking; and providing the information related to at least one of: the contact entry and the additional information item includes providing information related to the selected of the contact entry and the additional information item without providing any information related to the other of the contact entry and the additional information item.

In some implementations, providing the information related to at least one of: the contact entry and the additional information item includes providing information related to both the selected of the contact entry and the additional information item; wherein prominence of the information related to the contact entry is based on the ranking.

In some implementations, a computer implemented method may be provided that includes the steps of: identifying a query of a user; identifying, from one or more contacts collections associated with the user, a first contact entry based on one or more relationships between the query and the first contact entry; identifying, from the one or more contacts collections, a second contact entry based on one or more relationships between the query and the first contact entry; determining temporal data, the temporal data indicating one or more of a date and a time associated with submission of the query; and ranking the first contact entry relative to the second contact entry based on one or more relationships between the temporal data and the first contact entry and the second contact entry.

This method and other implementations of technology disclosed herein may each optionally include one or more of the following features.

In some implementations, the method further includes: selecting one of the first contact entry and the second contact entry based on the ranking; and providing information related to the selected of the first contact entry and the second contact entry without providing any information related to the other of the first contact entry and the second contact entry.

In some implementations, the method further includes providing information related to both the first contact entry and the second contact entry, wherein prominence of the first contact entry and the second contact entry in the provided information is based on the ranking.

Other implementations may include a non-transitory computer readable storage medium storing instructions executable by a processor to perform a method such as one or more of the methods described above. Yet another implementation may include a system including memory and one or more processors operable to execute instructions, stored in the memory, to perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example environment in which a contact entry of a user may be ranked relative to one or more additional information items and information provided that is related to the contact entry and/or the additional information items based on the ranking.

FIG. 2A illustrates an example of contact entries of a contacts collection of a user.

FIG. 2B illustrates an example of contact entries of another contacts collection of the user.

FIG. 3 is a flow chart illustrating an example method of ranking a contact entry of a user relative to an additional information item and providing information related to the contact entry and/or the additional information item.

FIG. 4 illustrates an example of a user interface for displaying, in response to a query, information related to contact entries of a user and information related to additional information items.

FIG. 5 illustrates an example of a user interface for displaying, in response to a query, information related to a contact entry of a user and information related to additional information items.

FIG. 6 illustrates an example of a user interface for displaying, in response to a query, information related to additional information items.

FIG. 7 illustrates another example of a user interface for displaying, in response to a query, information related to contact entries of a user and information related to additional information items.

FIG. 8 is a flow chart illustrating an example method of ranking a contact entry of a user relative to another contact entry of the user based on temporal data associated with submission of a query.

FIG. 9A illustrates an example of a user interface for displaying, in response to a query, information related to contact entries of a user.

FIG. 9B illustrates another example of a user interface for displaying, in response to a query, information related to contact entries of a user.

FIG. 9C illustrates another example of a user interface for displaying, in response to a query, information related to contact entries of a user.

FIG. 10 illustrates an example architecture of a computer system.

### DETAILED DESCRIPTION

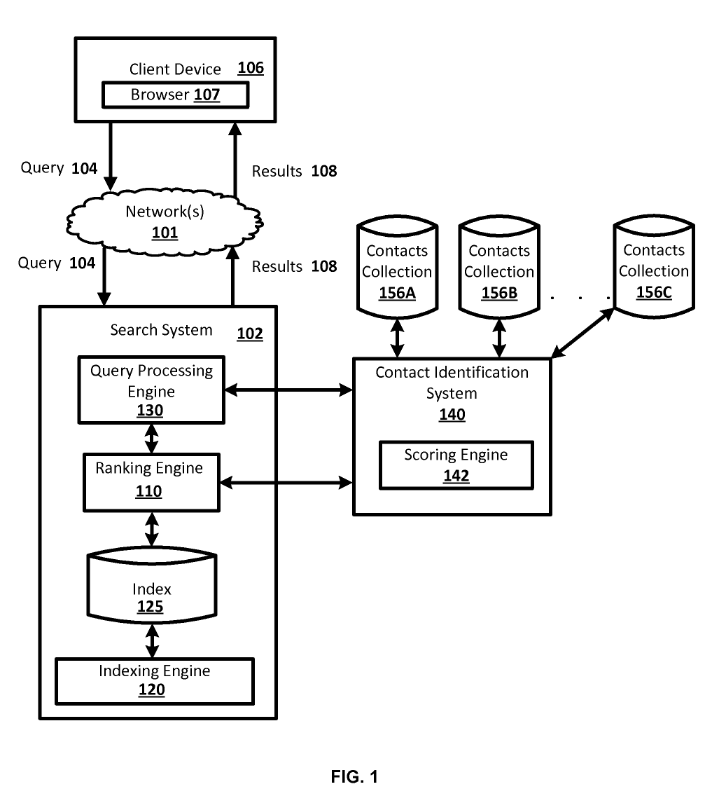

FIG. 1 illustrates an example environment in which a contact entry of a user may be ranked relative to one or more additional information items and information provided that is related to the contact entry and/or the additional information items based on the ranking. The example environment includes a client device 106, a search system 102, and a contact identification system 140. The example environment also includes contacts collections 156A, 156B, and 156C.

Each of the contacts collections 156A-C may include one or more contact entries of a user. A contact entry includes information identifying a set of one or more properties of an entity. For example, a contact entry for an individual may include a structured data set defining one or more aliases, phone numbers, email addresses, addresses, occupations, uniform resource locators (URLs), descriptive notes, images, temporal data, frequency of interaction data, location data, and/or other properties associated with the individual. In some implementations, more or fewer (e.g., one) contacts collections may be associated with a user and/or utilized in techniques described herein. In some implementations, one or more of contacts collections 156A-C may be stored locally on the client device 106 and/or on another computing device associated with client device 106 and/or associated with a user of the client device 106. In some implementations, one or more of contacts collections 156A-C may include one or more of the same contact entries as contact entries stored on the client device 106 or other computing device of a user of the client device 106. For example, one or more of contacts collections 156A-C may be synched with contact entries on the client device 106 on a periodic or other basis.

In some implementations, each of the contacts collections 156A-C may include contact entries from a distinct source. For example, contacts collection 156A may be a contacts collection of client device 106 (stored locally on client device 106 or synched from client device 106), contacts collection 156B may be a contacts collection of an email account of a user of client device 106, and contacts collection 156C may be a contacts collection of a social networking account of a user of client device 106. In some implementations, one or more of the contacts collections 156A-C may be identified for the user of client device 106 based on account information or other identifier/authorization of the user. For example, the client device 106 may provide account information and authorization to the search system 102 and/or the contact identification system 140 to enable such components to identify and access contacts collections 156A-C.

In some implementations, one or more of the contacts collections 156A-C may include information items of a plurality of users and access to information items of a user in one or more of contacts collections 156A-C may be allowed for only the user and/or one or more other users or components authorized by the user such as contact identification system 140. In some implementations, each user may have control over whether and/or which contacts are provided for inclusion in the contacts collections 156A-C. In some implementations, each user may have control over whether and/or which of the contacts collections 156A-C and/or which of the contact entries of the contact collections 156A-C may be accessed by one or more components such as contact identification system 140. In some implementations, each user may have the ability to remove contacts of the user included in the contacts collections 156A-C.

In this specification, the term “contacts collection” will be used broadly to refer to any collection of contact entries. The data of the contacts collection does not need to be structured in any particular way, or structured at all, and it can be stored on storage devices in one or more locations. Thus, for example, the contacts collections 156A-C may each be organized and accessed differently. Also, in this specification, the term “entry” will be used broadly to refer to any mapping of a plurality of associated information items. A single entry need not be present in a single storage device and may include pointers or other indications of information items that may be present on other storage devices. For example, an entry may include multiple nodes mapped to one another, with each node including an identifier of an entity or other information item that may be present in another data structure and/or another storage medium. In some implementations, a contacts collection may include or be associated with an index of contact entries of the collection to enable efficient identification of which contact entries, if any, are responsive to a query.

The search system 102 is an example of an information retrieval system in which the systems, components, and techniques described herein may be implemented and/or with which systems, components, and techniques described herein may interface. In some implementations, one or more components illustrated in FIG. 1 as part of the search system 102 may be provided separate from the search system 102. For example, in some implementations query processing engine 130 and/or ranking engine 110 may be provided in a system that is separate from the search system 102. Also, in some implementations the contact identification system 140 may be incorporated as part of the search system 102.

In the example environment of FIG. 1, a user may interact with the search system 102 via the client device 106. The search system 102 receives a query 104 from the client device 106 and returns search results 108 to the client device 106 in response to the query 104. In FIG. 1 the search system 102 is illustrated as separate from the client device 106. In other implementations, the search system 102 may be implemented, in whole or in part, on the client device 106. For example, in some implementations the search system 102 may be an information retrieval system of the client device 106 and may retrieve information items that are locally stored on the client device 106, such as contact entries, documents, and/or other information items such as those described herein.

Each query 104 is a request for information. The query 104 can be, for example, in a text form and/or in other forms such as, for example, audio form and/or image form. Other computer devices may submit search queries to the search system 102 such as additional client devices and/or one or more servers implementing a service for a website that has partnered with the provider of the search system 102. For brevity, however, the examples are described in the context of the client device 106. Also, while the user of the client device 106 may operate a plurality of client devices, for the sake of brevity, examples described in this disclosure will focus on the user operating client device 106. However, it is understood that certain information associated with a user of client device 106 described herein may be sent to, received from, and/or based on additional and/or alternative client devices of the user.

In some implementations, the query 104 may be processed by query processing engine 130. In some of those implementations, the query processing engine 130 may reformulate the query 104 and provide the reformulated query to the ranking engine 110 and/or the contact identification system 140. For example, for a query of “Bob's phone number” the query processing engine 130 may provide a reformulated query that indicates the query is seeking a type of contact information of “phone number” for a contact having an alias of “Bob”. Also, for example, for a query of “what is Bob's email address” the query processing engine 130 may provide a reformulated query that indicates the query is seeking a type of contact information of “email address” for a contact having an alias of “Bob”. Also, for example, for a query of “Call Bob” the query processing engine 130 may provide a reformulated query that indicates the query is seeking to perform an action of “calling” that is associated with a type of contact information of “phone number” for a contact having an alias of “Bob”.

In some implementations, query processing engine 130 may be configured to identify one or more components of a query 104 and annotate one or more types of information for one or more of the identified components. Each of the components may include or be based on one or more terms of the query. For example, the query processing engine 130 may annotate one or more types of grammatical information for terms of query 104 (e.g., annotate parts of speech of the terms, syntactic relationships between the terms) and segment the query 104 into components based on the annotations of grammatical information and one or more rules. Also, for example, the query processing engine 130 may be configured to annotate information for components of a query 104 based on the annotations of grammatical information and one or more rules. For example, one or more of the components of the query 104 may be annotated as being associated a particular type of contact information such as an alias, an address, an email address, a phone number, etc. based on the annotation and/or rules.

In some implementations, query processing engine 130 may additionally and/or alternatively be configured to determine a contact indication measure associated with query 104. A contact indication measure is generally indicative of likelihood the query 104 seeks contact information. For example, there may be a higher likelihood that the query “what is bryan's phone number” seeks contact information than the query “bryan” and the query processing engine 130 may determine contact indication measures for each of the queries that reflect such likelihoods. In some implementations, a contact indication measure be expressed as a numeric or alphabetical value along a range, e.g., from zero to one. In some implementations, a contact indication measure may be expressed in a binary fashion, e.g., as positive (e.g., “true”) or negative (e.g., “false”).

In some implementations, the query processing engine 130 may determine the contact indication measure based on one or more properties related to submission of the query 104. For example, a query submitted from a computing device that is a mobile device may be more likely to seek contact information than a query submitted from a computing device that is a desktop device. Also, for example, a voice query may be more likely to seek contact information than a typed query. Also, for example, a query issued via a first interface such as an interface utilized to search information that is local to a computing device in addition to information that is not local to the computing device may be more likely to seek contact information than a query issued via a second interface such as an interface that is primarily utilized to search information that is not local to the computing device.

In some implementations, the query processing engine 130 may additionally and/or alternatively determine the contact indication measure based on one or more properties of the query 104 itself. For example, the contact indication measure may be determined based on presence and/or absence of certain terms and/or types of terms. For example, the presence of name(s), contact terms such as “number”, “address”, or “call”, and/or presence of “what”, “?”, may all be indicative of seeking contact information. Also, for example, the contact indication measure may be based on one or more statistical measures associated with past actions of the user and/or additional users responsive to one or more terms of the query, such as the query as a whole. For example, a statistical measure for one or more terms of a query may be based on selection rates of contact information in response to queries including the one or more terms and/or selection rates of non-contact information in response to the queries including the one or more terms.

In some implementations, the query processing engine 130 may receive as input one or more signals associated with query 104 and provide as output an indication of one or more features associated with the query 104. In some of those implementations, the query processing engine 130 may utilize classifier and/or rules based approaches to determine one or more features based on the one or more signals. For example, the query processing engine 130 may utilize one or more regular expressions to segment a query into components and/or annotate information for components of a query. Also, for example, the query processing engine 130 may utilize a classifier trained to determine a contact indication measure for a query. Any classifier utilized by the query processing engine 130 may be trained, for example, utilizing one or more supervised or semi-supervised training techniques.

The signals provided as input to the query processing engine 130 for a query may include signals based on content of the query itself such as one or more terms of the query, parts of speech associated with one or more terms of the query, relationships between one or more terms of the query and/or other information associated with the query such as properties related to submission of the query and/or statistical measures associated with the query. In some implementations, the query processing engine 130 may include and/or be in communication with an annotator configured to identify and annotate various types of grammatical information in one or more terms of the query and the annotations may be utilized as signals by the query processing engine 130. For example, the annotator may include: a part of speech tagger configured to annotate terms with their grammatical roles; a dependency parser configured to determine syntactic relationships between terms; an entity tagger configured to annotate entity references such as references to people, organizations, locations, and so forth; and/or a coreference resolver configured to group, or “cluster,” references to the same entity based on one or more contextual cues.

The client device 106 may be a computer coupled to the search system 102 through one or more networks 101 such as a local area network (LAN) or wide area network (WAN) (e.g., the Internet). In some other implementations, the search system 102 may be implemented in whole or in part on the client device 106. The client device 106 may be, for example, a desktop computing device, a laptop computing device, a tablet computing device, a mobile phone computing device, a computing device of a vehicle of the user (e.g., an in-vehicle communications system, an in-vehicle entertainment system, an in-vehicle navigation system), or a wearable apparatus of the user that includes a computing device (e.g., a watch of the user having a computing device, glasses of the user having a computing device). Additional and/or alternative client devices may be provided. The client device 106 typically includes one or more applications to facilitate submission of queries and the sending and receiving of data over a network. For example, the client device 106 may execute one or more applications, such as a browser 107, that allow users to formulate and submit queries to the search system 102.

The search system 102 includes an indexing engine 120 and a ranking engine 110. The indexing engine 120 maintains an index 125 for use by the search system 102. In some implementations, the indexing 125 includes information items that are not contact entries of the user. In some versions of those implementations, the indexing 125 does not include any contact entries of the user. The indexing engine 120 processes information items and updates index entries in the index 125, for example, using conventional and/or other indexing techniques. For example, in some implementations the indexing engine 120 may crawl one or more resources and index documents accessed via such crawling. For example, the indexing engine 120 may crawl one or more publicly accessible resources such as the World Wide Web and index documents accessed via such crawling. Also, for example, the indexing engine 120 may receive information related to one or more documents from one or more resources such as web masters controlling such documents and index the documents based on such information. A document is any data that is associated with a document identifier such as, but not limited to, a uniform resource locator (“URL”). Documents include web pages, word processing documents, portable document format (“PDF”) documents, images, videos, to name just a few. Each document may include content such as, for example: text, images, videos, sounds, embedded information (e.g., meta information and/or hyperlinks); and/or embedded instructions (e.g., ECMAScript implementations such as JavaScript).

In some implementations, the indexing engine 120 may additionally and/or alternatively process non-publicly accessible information items that are associated with a user and update the index 125 with such information items. For example, in some implementations, the indexing engine 120 may operate on the client device 106 and process information items on the client device 106 that are not contact entries of the user. Also, for example, in some implementations, the indexing engine 120 may operate remote from the client device 106 and process non-publicly accessible information items provided by the client device 106 (e.g., non-public documents, browsing history of the user). In some implementations, access to any non-publicly accessible information items that are associated with a user in the index 125 may be restricted to the user and/or one or more components authorized by the user such as search system 102 and/or contact identification system 140. Some examples of non-publicly accessible non-contact entry information items associated with the user include: browsing history of the user; documents of the user such as e-mails, pictures, videos, and/or audio files; and/or information related to applications installed on a computing device of the user. Examples further include non-publicly accessible information items of another user to which the user has been permitted access. For example, one or more users may share pictures and/or other information items with the user and those pictures and/or other information items may be non-publicly accessible non-contact entry information items associated with the user.

The ranking engine 110 uses the index 125 to identify information items responsive to the query 104, for example, using conventional and/or other information retrieval techniques. The ranking engine 110 calculates scores for the information items identified as responsive to the query 104, for example, using one or more ranking signals.

In some implementations, ranking signals used by ranking engine 110 to calculate scores for the information items may include information about the query 104 itself such as, for example, the terms of the query, an identifier of the user who submitted the query, and/or a categorization of the user who submitted the query (e.g., the geographic location from where the query was submitted, the language of the user who submitted the query, and/or a type of the client device 106 used to submit the query (e.g., mobile device, laptop, desktop)). For example, ranking signals for a document may include information about the terms of the query 104 such as, for example, the locations where a query term appears in the title, body, and text of anchors in a document, how a term is used in the document (e.g., in the title of the document, in the body of the document, or in a link in the document), the term frequency (i.e., the number of times the term appears in a corpus of documents in the same language as the query divided by the total number of terms in the corpus), and/or the document frequency (i.e., the number of documents in a corpus of documents that contain the query term divided by the total number of documents in the corpus).

Also, for example, ranking signals used by ranking engine 110 to calculate scores for the information items may additionally and/or alternatively include information about the information item. For example, information about a document may include, for example, a measure of the quality of the document, a measure of the popularity of the document, the URL of the document, the geographic location where the document is hosted, when the search system 102 first added the document to the index 125, the language of the document, the length of the title of the document, and/or the length of the text of source anchors for links pointing to the document.

Also, for example, ranking signals used by ranking engine 110 to calculate scores for the information items may additionally and/or alternatively include one or more ranking signals described with respect to the scoring engine 142 of contact identification system 140. For example, in some implementations ranking signals may include information related to the optional contact indication measure of the query 104. For example, the score of a non-contact entry information item may be demoted as the contact indication measure becomes more indicative of the query seeking contact information.

The search system 102 is in communication with a contact identification system 140. Generally, the contact identification system 140 uses the contacts collections 156A-C to identify one or more contact entries (if any) responsive to the query 104, for example, using conventional and/or other information retrieval techniques such as those described herein. The scoring engine 142 calculates scores for the contact entries identified as responsive to the query 104, for example, using one or more ranking signals such as those described herein. In some implementations, the contact identification system 140 may be incorporated, in whole or in part, in the client device 106. In some implementations, the contact identification system 140 may additionally and/or alternatively be incorporated in whole or in part in the search system 102. For example, in some implementations the contact identification system 140 may be incorporated as part of the ranking engine 110.

In some implementations, the contact identification system 140 receives a reformulated query from query processing engine 130 and utilizes the reformulated query to identify one or more contact entries responsive to the query. For example, a reformulated query may indicate a desire for contact information related to an alias of “Bob” and the query processing engine 130 may identify one or more contact entries that include “Bob” in the contact entry in general, or in an alias node of the contact entry in particular. In some implementations, indexes of the contacts collections 156A-C may be utilized to identify contact entries responsive to a query.

In some implementations, ranking signals used by scoring engine 142 in calculating a score for a contact entry may include information related to the optional contact indication measure of the query 104 that may be determined by the query processing engine 130. As described above, the contact indication measure is indicative of likelihood the query seeks contact information. Generally, the score of a contact entry may be promoted as the contact indication measure becomes more indicative of the query seeking contact information.

In some implementations, ranking signals used by scoring engine 142 in calculating a score for a contact entry may include information related to a degree of matching between the query and the contact entry. The degree of matching may be based on, for example, how many terms of the query match the contact entry, the type of terms of the query that match or fail to match the contact entry, and/or the type of nodes of the contact entry that match or fail to match the query. For example, matching 3 out of 5 terms of the query 104 to a contact entry may result in a more improved score for the contact entry than matching only 2 out of 5 terms. Also, for example, matching both an alias term and an occupation term of a query to nodes of a contact entry may result in a more improved score for the contact entry than matching only the occupation term and failing to match then name term. Also, for example, matching only a “name” node of a contact entry may result in a more improved score for the contact entry than matching only an “occupation” node of the contact entry. Also, for example, matching the entirety of a “name” node of a contact entry may result in a more improved score for the contact entry than matching only part of a “name” node of the contact entry. For example a query of “Bob Herman” for a contact entry with a “name” node of “Bob Herman” may result in a more improved score than a query of “Bob” for the same contact entry.

In some implementations, ranking signals used by scoring engine 142 in calculating a score for a contact entry may include information related to a location associated with the user submitting the query and/or a location associated with the contact entry. For example, the score may be promoted if the location associated with the contact entry is “near” the location of the user. Also, for example, two contact entries may be identified for a user query of “call bob” and a first contact entry associated with a location of California may be scored more prominently than a second contact entry associated a location of New York when the user is in or near California. On the other hand, if the user were in or near New York and issued the query of “call bob”, the second contact entry (associated with New York) may be scored more prominently than the first contact entry (associated with California). Locations associated with the contact entry and/or the user may be based on, for example, a home address associated with the contact entry and/or user, a work address associated with the contact entry and/or user, an address that is periodically or otherwise updated to reflect movement of the contact entry and/or user based on geolocation or other signals, etc.

In some implementations, ranking signals used by scoring engine 142 in calculating a score for a contact entry may include query temporal data related to a time and/or a date associated with submission of the query and contact entry temporal data related to a time and/or a date associated with the contact entry. For example, a contact entry may be associated with one or more dates (e.g., Weekends, Mondays, Friday or Saturday, Mother's Day, around tax day, around Holidays) and/or times (e.g., after 5:00, evenings, daytime, around noon) during which the user has interacted with the contact entry and the score of the contact entry may be promoted if the dates and/or times match those associated with submission of the query. Also, for example, a score of a contact entry may result in a more improved score for the contact entry if temporal data of the contact entry is near temporal data of the query than if the temporal data of the contact entry was farther from the temporal data of the query. Proximity of temporal data of a contact entry to temporal data of a query may be based on, for example, distance measure(s) between the dates and/or times of the temporal data of the contact entry and the query. In some implementations, the dates and/or times may optionally be associated with a communication type (e.g., call, e-mail, text) and the ranking signals based on the communication type. For example, if the query includes “phone number” or “call” the score of a contact entry responsive to the query may be promoted if temporal data of the contact entry indicates the user typically “calls” the contact during the time/date of the query. Also, for example, if the query is submitted via an interface of a phone application of a computing device the score of a contact entry responsive to the query may be promoted if temporal data of the contact entry indicates the user typically “calls” the contact during or near the time/date of the query.

In some implementations, ranking signals used by scoring engine 142 in calculating a score for a contact entry may include information related to a frequency of interaction of the user with the contact entry. For example, a contact entry may be associated with a frequency of interaction for all or particular communication types and a greater frequency of interaction may promote the score of the contact entry.

In some implementations, ranking signals used by scoring engine 142 in calculating a score for a contact entry may include information related to recency of interaction of the user with the contact entry and/or recency of interaction of the user with another contact entry associated with the contact entry. For example, a contact entry of a user may be associated with information indicating a time/date of the most recent interaction of the user with the entity of the contact entry for all or particular communication types (e.g., temporal data of the contact entry may optionally indicate this). An indication of a relatively recent interaction with the contact entry may promote the score of the contact entry more than if no indication of a relatively recent interaction was present. As one example, two contact entries may be identified for a user query of “call bob” and a first contact entry associated with information indicating the user most recently called (or, optionally, otherwise interacted with) the entity associated with the first contact entry three hours ago may be scored more prominently than a second contact entry associated with information indicating the user most recently called (or, optionally, otherwise interacted with) the entity associated with the second contact entry one month ago.

As another example, a contact entry of a user may be associated with information indicating that the contact entry is more likely to be interacted with by the user following interaction with one or more additional contact entries associated with the user. Such information may be determined based on a record of past interactions (e.g., interactions indicating interaction with the contact entry following interaction with the additional contact entry/entries) and/or based on one or more other associations between the contact entry and the one or more additional contact entries (e.g., the contact entries and the one or more additional contact entries are members of the same “circle” of friends of the user, are often both included on e-mails or other correspondence of the user, share a large number of contacts in common, etc.). For example, two contact entries may be identified for a user query of “call bob” after the user has called “Janet”. A first contact entry of the two contact entries may be associated with information indicating the user is highly likely to interact with the first contact entry following interaction with “Janet” and the score of the first contact entry may be promoted based on such information.

In some implementations, ranking signals used by scoring engine 142 in calculating a score for a contact entry may include information related to a commonality measure between the user and the contact entry. The commonality measure may be generally indicative of a degree of shared attributes between the user and the contact entry. For example, the commonality measure for a contact entry of a user may be based on: a quantity of social connections that the user and the contact entry share (e.g., based on social networking data of each); a quantity of addresses, locations, entities, etc. that the user and the contact entry share (e.g., in contact entries or other data associated with the users); whether the user and the contact entry share the same workplace, the same school(s), and/or the same hometown; and/or additional and/or alternative attributes shared or not shared between the user and the contact entry. Generally, a commonality measure indicative of a large degree of shared attributes between a user and a contact entry may promote the score of the contact entry more than a commonality measure indicative of a lesser degree of shared attributes.

In some implementations, ranking signals used by scoring engine 142 in calculating a score for a contact entry may include information related to a current context associated with the user. For example, in some implementations if the current context indicates the user is on vacation the score of contact entries may be demoted more than if the user is not on vacation. Also, for example, in some implementations if the current context indicates the user is on vacation the score of certain contact entries may be promoted (e.g., those the user typically interacts with while on vacation) and/or the score of certain other contact entries may be demoted (e.g., those the user never or rarely interacts with while on vacation). Also, for example, in some implementations if the current context indicates the user is in a meeting (e.g., based on calendar data of the user) the score of the contact entries may be demoted more than if the user is not in a meeting. Also, for example, in some implementations if the current context indicates the user is in a meeting the score of certain contact entries may be promoted (e.g., those that are indicated as attendees of the meeting or otherwise associated with the meeting) and/or the score of certain other contact entries may be demoted (e.g., those that are not associated with the meeting). Also, for example, if the current context indicates the user is in a state in which they typically contact entities (e.g., based on historical data for the user), these contact entries may be promoted globally more than if the user is not in such a state. For example, historical data of the user, such as temporal data of a plurality of contact entries, may indicate the user typically contacts people during certain times, on certain dates, and/or while engaged in certain activities. Scores for contact entries during such times, dates, and/or while engaged in such activities may be promoted. Additional and/or alternative current contexts associated with the user may be utilized such as current contexts that indicate the user is driving, watching television, playing games, dining, shopping, and so forth. Moreover, parameters for globally determining scores for contact entries and/or determining scores for particular contact entries (e.g., those of a particular class) may optionally be adapted for each of one or more of a plurality of current contexts.

In some implementations, ranking signals used by scoring engine 142 in calculating a score for a contact entry may include information related to an affinity measure associated with the contacts collection from which the contact entry is identified. For example, the user's social network contacts collection may have an affinity measure most indicative of affinity, followed by a contacts collection associated with the user's mobile phone, followed by a contacts collection associated with the user's e-mail. The affinity measure for one or more contacts collections may be global and/or adapted to the user. For example, the affinity measure for a contacts collection may be a set global affinity measure, may be based on global usage statistics related to the contacts collection, may be based on the user's usage statistics related to the contacts collection, and/or may be based on usage statistics related to the contacts collection of a group of users sharing one or more attributes with the user.

Scoring engine 142 may utilize all or aspects of one or more of the ranking signals described herein and/or additional or alternative ranking signals in calculating a score for each of one or more contact entries. For example, scoring engine 142 may calculate a score for each of one or more contact entries identified for a query based on all, or aspects of, one or more of: a contact indication measure of the query; information related to a degree of matching between the query and the contact entry; a location associated with the user submitting the query and/or a location associated with the contact entry; temporal data associated with submission of the query and temporal data associated with the contact entry; a frequency of interaction of the user with the contact entry; a current context associated with the user; a commonality measure associated with the contact entry; and/or an affinity measure associated with the contacts collection from which the contact entry is identified.

The contact identification system 140 may provide information related to one or more responsive contact entries, and respective scores for the contact entries, to the ranking engine 110. In some implementations, the contact identification system 140 only provides those contact entries (if any) having a score that satisfies a threshold. The ranking engine 110 ranks the one or more contact entries provided by the contact identification system 140 and any other information items identified via the index 125 using the scores. For example, the ranking may be based on the scores of the one or more contact entries as determined by scoring engine 142 and may be based on the scores of any other information items as determined by ranking engine 110.

The search system 102 uses the responsive information items ranked by the ranking engine 110 to generate all or portions of search results 108. For example, the search results 108 based on responsive contact entries (if any) can include some or all of the information from the contact entries, a link to additional information from a respective of the contact entries, and/or a link to perform an action via client device 106 that is based on the respective contact entry (e.g., to “call” a number in the respective contact entry, to e-mail an email address in the respective contact entry). Also, for example, the search results 108 based on responsive documents (if any) can include a title of a respective of the documents, a link to a respective of the documents, and/or a summary of content from a respective of the documents that is responsive to the query 104. For example, the summary of content may include a particular “snippet” or section of a document that is responsive to the query 104.

The search results 108 are provided to the client device 106 in a form that may be presented to the user. For example, the search results 108 may be transmitted as a search results web page to be displayed via the browser 107 executing on the client device 106, as a search results interface to be displayed via another application executing on the client device 106, and/or as one or more search results conveyed to a user via audio. In implementations in which the search system 102 is implemented on the client device 106, providing the search results 108 may include providing the search results for display and/or other conveyance to a user via the client device 106.

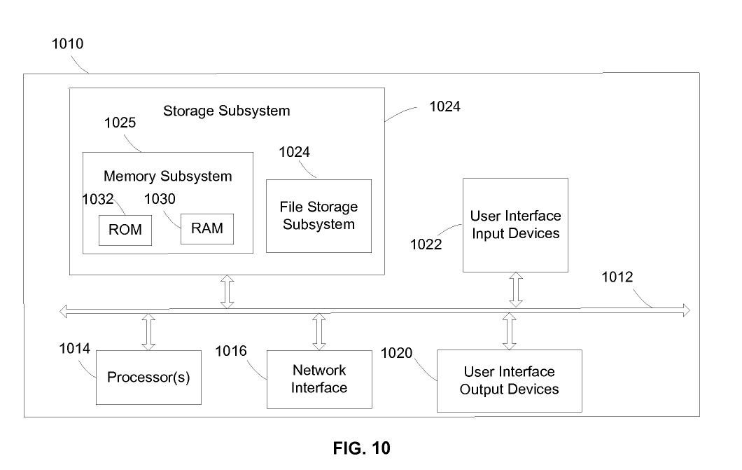

The search system 102, the contact identification system 140, the client device 106, and/or one or more additional components of the example environment of FIG. 1 may each include memory for storage of data and software applications, a processor for accessing data and executing applications, and components that facilitate communication over a network. In some implementations, such components may include hardware that shares one or more characteristics with the example computer system that is illustrated in FIG. 10. The operations performed by one or more components of the example environment may optionally be distributed across multiple computer systems. For example, the steps performed by the search system 102 and/or contact identification system 140 may be performed via one or more computer programs running on one or more servers in one or more locations that are coupled to each other through a network.

Many other configurations are possible having more or fewer components than the environment shown in FIG. 1. For example, in some implementations the contact identification system 140 may the search system 102 may be combined. Also, for example, the contact identification system 140 and/or the search system 102 may be included in the client device 106. Further description of components of FIG. 1 is provided below.

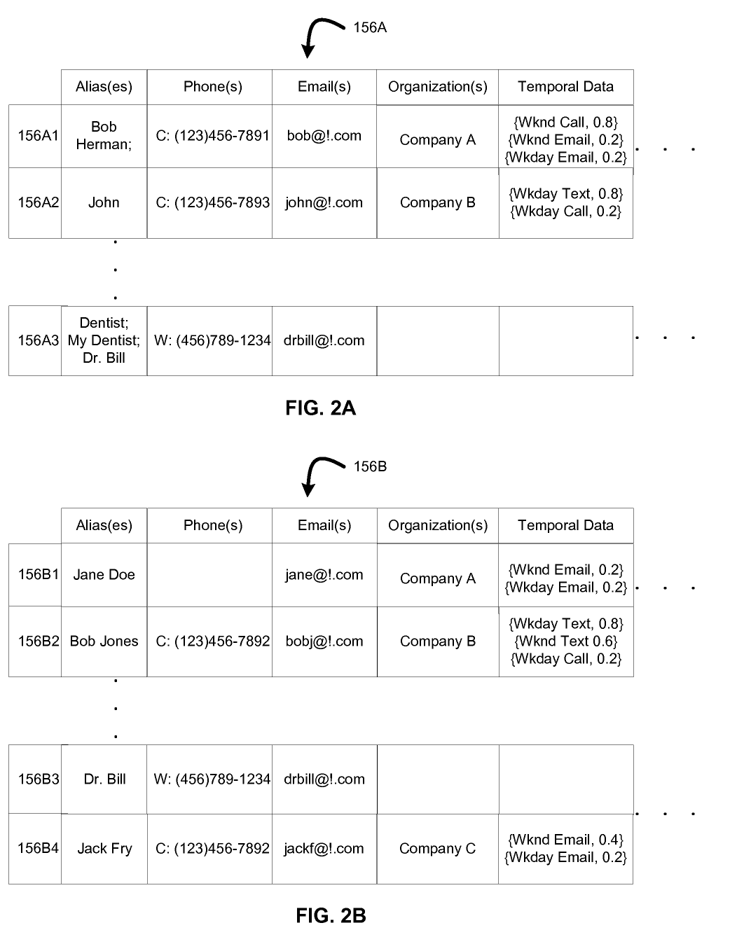

FIG. 2A illustrates an example of contact entries 156A1, 156A2, and 156A3 of contacts collection 156A. The contact entries 156A1-A3 are each contact entries of a user of the client device 106. Although three contact entries are illustrated in FIG. 2A, the ellipsis between contact entry 156A2 and contact entry 156A3 is provided to indicate that additional contact entries may be included. Each of the contact entries 156A1-A3 includes associated information for one or more of alias(es), phone(s), email(s), organization(s), and temporal data nodes. For example, contact entries 156A1 and 156A2 include associated information for each of the aforementioned nodes, whereas contact entry 156A3 includes associated information for only three of the nodes. Although five particular nodes are illustrated in FIG. 2A, additional and/or alternative nodes may be provided. For example, the ellipses to the right of the contact entries are provided to indicate that additional nodes may be included. As described, the contacts collection 156A may be stored on the client device 106, another client device of the user, and/or remote from a client device of the user.

FIG. 2B illustrates an example of contact entries 156B1, 156B2, 156B3, and 156B4 of contacts collection 156B. The contact entries 156B1-B4 are each contact entries of a user of the client device 106. Although four contact entries are illustrated in FIG. 2B, the ellipsis between contact entry 156B3 and contact entry 156B4 is provided to indicate that additional contact entries may be included. Each of the contact entries 156B1-B4 includes associated information for one or more of alias(es), phone(s), email(s), organization(s), and temporal data nodes. Although five particular nodes are illustrated in FIG. 2B, additional and/or alternative nodes may be provided. For example, the ellipses to the right of the contact entries are provided to indicate that additional nodes may be included. Also, although the same nodes are present in FIG. 2A and FIG. 2B, in some implementations contacts collection 156A and contacts collection 156B may include one or more nodes that are different from one another. As described, the contacts collection 156B may be stored on the client device 106, another client device of the user, and/or remote from a client device of the user. Further description of FIGS. 2A and 2B is provided herein.

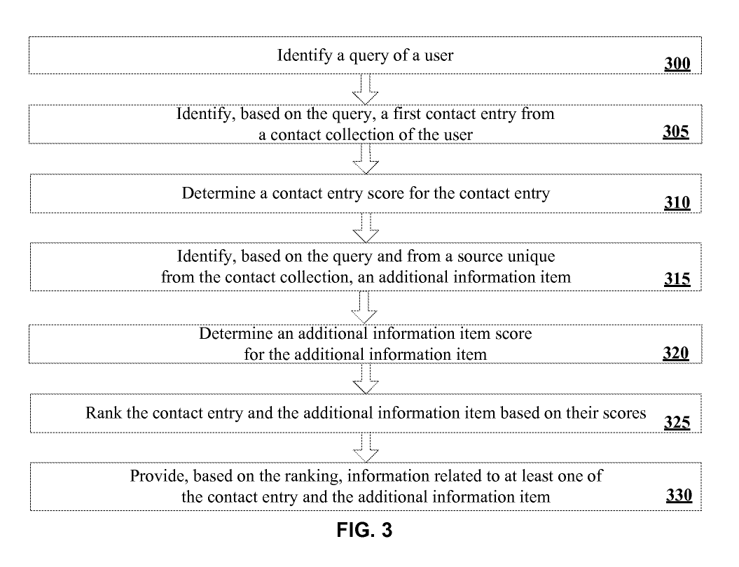

FIG. 3 is a flow chart illustrating an example method of ranking a contact entry of a user relative to an additional information item and providing information related to the contact entry and/or the additional information item. Other implementations may perform the steps in a different order, omit certain steps, and/or perform different and/or additional steps than those illustrated in FIG. 3. For convenience, aspects of FIG. 3 will be described with reference to a system of one or more computers that perform the process. The system may include, for example, the contact identification system 140 and/or the search system 102 of FIG. 1.

At step 300, a query of a user is identified. For example, the search system 102 may receive a query that is provided via client device 106 in a text form and/or in other form.

At step 305, a contact entry is identified from a contact collection of the user based on the query. For example, the contact identification system 140 may use one of the contacts collections 156A-C to identify a contact entry responsive to the query 104, for example, using conventional and/or other information retrieval techniques such as those described herein. For example, the contact identification system 140 may identify a contact entry that includes one or more nodes with information matching one or more terms of the query. Soft matching and/or exact matching techniques may be utilized. In some implementations, the query processing engine 130 reformulates the query identified at step 300, provides the reformulated query to the contact identification system 140, and the contact identification system 140 utilizes the reformulated query to identify a contact entry responsive to the query. For example, a reformulated query may indicate a desire for contact information related to a particular alias and the query processing engine 130 may identify one or more contact entries that include the particular alias in the contact entry in general, or in an alias node of the contact entry in particular. In some implementations, one or more additional contact entries may also be identified from the contact collection at step 305. For example, the contact identification system 140 may identify multiple contact entries that each includes one or more nodes with information matching one or more terms of the query.

At step 310, a contact entry score for the contact entry is determined. In some implementations, the scoring engine 142 calculates a score for the contact entry using one or more ranking signals such as those described herein. For example, ranking signals used by scoring engine 142 in calculating a score for a contact entry may include information related to: a contact indication measure of the query; information related to a degree of matching between the query and the contact entry; a location associated with the user submitting the query and/or a location associated with the contact entry; temporal data associated with submission of the query and temporal data associated with the contact entry; a frequency of interaction of the user with the contact entry; a current context associated with the user; a commonality measure associated with the contact entry; and/or an affinity measure associated with the contacts collection from which the contact entry is identified. In implementations where multiple contact entries are identified at step 305, a contact entry score may optionally be determined for each of the identified contact entries at step 310.

At step 315, an additional information item is identified based on the query from a source distinct from the contact collection from which the contact entry of step 305 was identified. In some implementations, the source distinct from the contact collection is another contact collection and the additional information item is another contact entry. In some implementations, the source distinct from the contact collection is another index or other database that includes information items such as publicly accessible documents, and/or other non-contact entry information items associated with the user. For example, the source distinct from the contact collection may be an index that includes publicly accessible resources such as an index based on crawling of the World Wide Web. In some implementations, one or more additional information items may also be identified at step 315.

At step 320, an additional information item score for the additional information item is determined. In some implementations where the additional information item is an additional contact entry, the scoring engine 142 calculates scores for the additional contact entry using one or more ranking signals such as those described herein (e.g., one or more of those described with respect to step 310). In some implementations where the additional information item score is not a contact entry, the ranking engine 110 of search system 102 calculates scores for the additional information item using one or more ranking signals such as those described herein (e.g., one or more of those described with respect to ranking engine 110). In some versions of those implementations, one or more ranking signals utilized to determine the score for the additional information item that is not a contact entry may be distinct from one or more signals utilized to determine the score for the contact entry at step 310. For example, when the additional information item is a publicly accessible document a ranking signal may be based on a measure of the popularity of the document among a population of multiple users and such a ranking signal may not be utilized to determine the score for the contact entry at step 310. In implementations where multiple additional information items are identified at step 315, an additional information item score may optionally be determined for each of the identified additional information items at step 320.

At step 325, the contact entry and the additional information item are ranked based on their scores. In some implementations, the ranking engine 110 of the search system 102 may rank the contact entry and the additional information item based on their scores. In some implementations, ranking the contact entry and the additional information item may include determining prominence for information related to the contact entry and/or determining prominence for information related to the additional information item. For example, ranking the contact entry and the additional information item may include determining which of the information related to the additional information item and the information related to the contact entry to provide more prominently based on their scores. Also, for example, ranking the contact entry and the additional information item may include determining how prominently to display or otherwise provide information related to the contact entry based on the score of the contact entry and/or the score of the additional information item. Also, for example, ranking the contact entry and the additional information item may include determining how prominently to display or otherwise provide information related to the additional information item based on the score of the additional information item and/or the score of the contact entry.

In some implementations, ranking the contact entry and the additional information item may include selecting one of the contact entry and the additional information item and rejecting the other of the contact entry and the additional information item. For example, ranking the contact entry and the additional information item may include selecting the contact entry and rejecting the additional information item based on the score of the contact entry and the score of the additional information item. Also, for example, ranking the contact entry and the additional information item may include selecting the additional information item and rejecting the contact entry based on the score of the contact entry and the score of the additional information item.

In some implementations, ranking the contact entry and the additional information item based on the additional information item score may include ranking them based on a cumulative score that takes into account the additional information item score. For example, when the additional information item is a publicly accessible document, raking the contact entry and the additional information item based on the additional information item score may include ranking them based on a cumulative score that takes into account the additional information item score and one or more scores of other publicly accessible documents responsive to the query (e.g., a cumulative score that reflects the score of a plurality of documents responsive to a query).

In implementations where multiple contact entries and/or multiple additional information items are identified, they may be ranked relative to one another. For example, they may be ranked based on their scores to determine prominence of contact entries and/or additional information items and/or whether to select one or more of the contact entries and/or additional information items. For instance, multiple contact entries may be ranked relative to one another to determine prominence of the contact entries relative to one another and/or whether to select all or a subset of the contact entries. Also, for instance, multiple additional information items may be ranked relative to one another to determine prominence of the additional information items relative to one another and/or whether to select all or a subset of the additional information items. Also, for instance, one or more contact entries may be ranked relative to one or more additional information items to determine prominence of the contact entries relative to the additional information items and/or whether to select all or a subset of the contact entries and the additional information items.

At step 330, information related to at least one of the contact entry and the additional information item is provided based on the ranking. For example, information related to both the contact entry and the additional information item may be provided based on the ranking. Also, for example, information related to only a selected of the contact entry and the additional information item may be provided based on the ranking. In implementations where multiple contact entries and/or multiple additional information items are identified, information related to multiple of the contact entries and/or multiple additional information items may be provided at step 330 (e.g., where multiple contact entries and/or multiple additional information items are selected based on the ranking at step 325).

In some implementations, the search system 102 may provide the information to the client device as search results 108. For example, the search results 108 based on responsive contact entries can include some or all of the information from the contact entries, a link to additional information from a respective of the contact entries, and/or a link to perform an action via client device 106 that is based on the respective contact entry (e.g., to “call” a number in the respective contact entry, to e-mail an email address in the respective contact entry). Various techniques may be utilized in determining what information to provide based on a contact entry, such as techniques described above with respect to determining scores. For example, what is provided may be based on the query, the score of the contact entry, the most frequent types of interaction with the contact of the contact entry, the most recent type of interaction, etc.

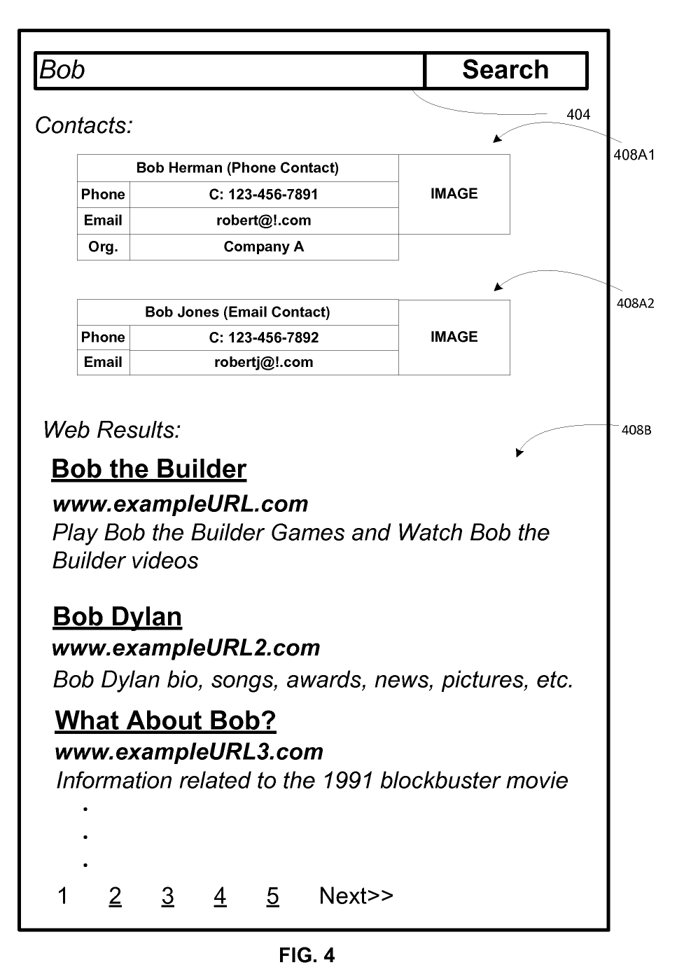

With reference to FIGS. 4-7, examples are described of ranking one or more contact entries of FIG. 2A and/or FIG. 2B and additional information items that are not contact entries
and providing search results based on the ranking.

FIG. 4 illustrates an example of a user interface for displaying, in response to a query, information related to contact entries of a user and information related to additional information items. The user interface includes a search field 404 and a search button to the right of the search field 404. In this example, the user has entered the query “Bob” into the search field 404 and search results are displayed that are responsive to the query. The search results may be displayed in response to the user selecting the search button or otherwise indicating a completed query and/or may be displayed before the user has indicated completion (e.g., the results may update as the user types the query). The search results include information 408A1 related to contact entry 156A1 (FIG. 2A) of a contacts collection 156A of the user, information 408A2 related to the contact entry 156B2 (FIG. 2B) of another contacts collection 156B of the user, and information 408B related to publicly accessible documents from another source (e.g., identified from index 125).

In some implementations, the contact identification system 140 may determine the contact entries 156A1 and 156B2 are responsive to the query “Bob” based on, for example, matching of the term “Bob” to information in the alias nodes of the contact entries 156A1 and 156B2. The scoring engine 142 may determine a score for each of the contact entries 156A1 and 156B2 based on one or more signals described herein. For example, in some implementations the contacts collection 156A includes phone contacts and the contacts collection 156B includes email contacts and scoring engine 142 may determine a score for the contact entry 156A1 that is higher than the score for contact entry 156B1 based on the contacts collection 156A having an affinity measure that is more indicative of affinity than the contacts collection 156B. The ranking engine 110 may determine to provide the contact entry 156A1 more prominently than the contact entry 156B1 based on their scores. For example, the information provided by the search system 102 to enable display of the interface of FIG. 4 may include information indicating the information related to contact entry 156A1 is to be displayed in a more prominent position than the information related to the contact entry 156B1 as illustrated in FIG. 4. Also, for example, information provided by the search system 102 to enable display of the interface of FIG. 4 may include more information related to contact entry 156A1 than related to contact entry 156B1. For example, in FIG. 4 information 408A1 includes an indication of an organization associated with the contact entry 156A1, whereas the information 408A2 does not include an indication of an organization associated with the contact entry 156B1.

The information 408B includes three separate search results, each including a title of, URL of, and snippet from a publicly accessible document (additional search results may be provided as indicated by the ellipsis). In some implementations, the ranking engine 110 may determine the publicly accessible documents related to information 408B are responsive to the query “Bob” based on, for example, matching of the term “Bob” to information for those publicly accessible documents in the index 125. The ranking engine 110 may determine a score for each of the identified publicly accessible documents and/or a cumulative score for the publicly accessible documents based on one or more signals described herein. The ranking engine 110 may rank the publicly accessible documents to determine a presentation order of the information 408B. For example, the ranking engine 110 may determine the document associated with “www.exampleurl.com” is the highest ranked document based on the scores and provide information related to that document more prominently than information related to other publicly accessible documents.

In some implementations, the ranking engine 110 may determine to provide the information 408B in combination with the information 408A1 and 408A2 based on one or both of the scores of the contact entries 156A1 and 156B1. For example, the scores for the contact entries 156A1 and 156B1 may be relatively low based on, for example, a contact indication measure associated with the query “Bob” that is indicative of a relatively low likelihood the query 104 seeks contact information. Based on the relatively low scores, the ranking engine 110 may determine to provide the information 408B in combination with the information 408A1 and 408A2. In some implementations, the ranking engine 110 may determine the publicly accessible documents related to information 408B only when the scores of the contact entries 156A1 and 156B1 fail to satisfy a threshold. In some implementations, the ranking engine 110 may determine whether to provide, and/or how to provide the information 408B based on the scores of the publicly accessible documents related to information 408B. For example, the information 408B may be provided only when the score of one or more of the publicly accessible documents satisfies a threshold and/or when a cumulative score satisfies a threshold.

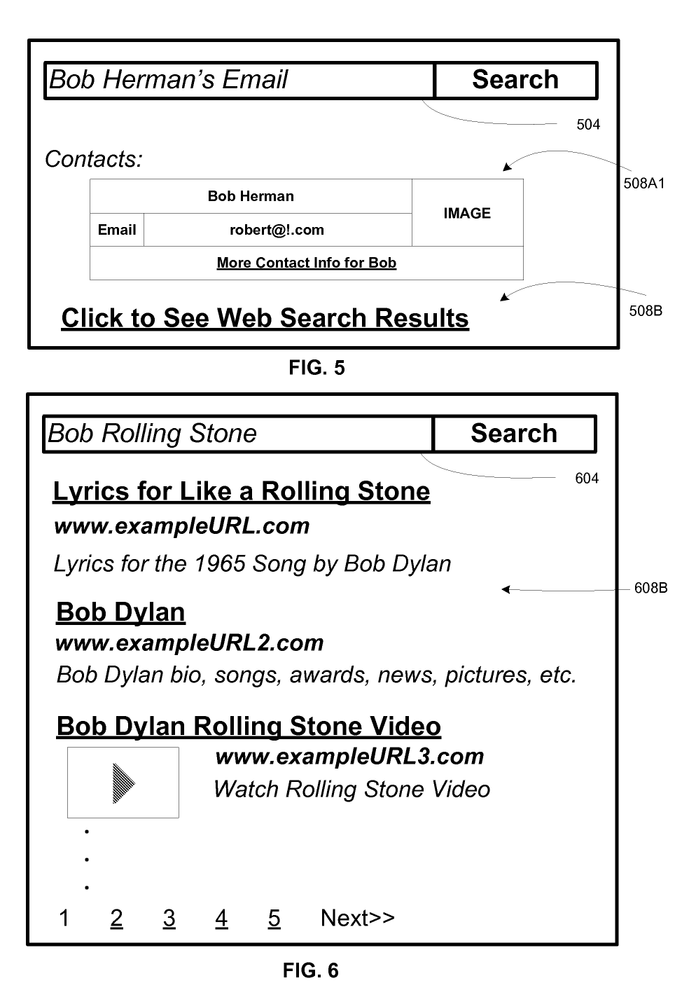

FIG. 5 illustrates an example of a user interface for displaying, in response to a query, information related to a contact entry of a user and information related to additional information items. In this example, the user has entered the query “Bob Herman's Email” into a search field 504 and search results are displayed that are responsive to the query. The search results include information 508A1 related to contact entry 156A1 (FIG. 2A) of a contacts collection 156A of the user and information 508B related to publicly accessible documents from another source (e.g., identified from index 125).

In some implementations, the contact identification system 140 may determine the contact entry 156A1 is responsive to the query “Bob Herman's Email” based on, for example, matching of the term “Bob Herman” to information in the alias node of the contact entry 156A1. The scoring engine 142 may determine a score for the contact entry 156A1 based on one or more signals described herein. For example, the score for the contact entry 156A1 in the example of FIG. 5 may be higher than the score for the contact entry 156A1 in the example of FIG. 4 based on one or more factors. For example, in the example of FIG. 5 there is a full name match between “Bob Herman” and the alias node of the contact entry 156A1 whereas only a partial name match (“Bob”) was present in the example of FIG. 4. Also, for example, in the example of FIG. 5 the contact indication measure for the query “Bob Herman's Email” may be more indicative of likelihood contact information is being sought than the contact indication measure for the query of FIG. 4 based on, for example, the presence of an additional alias term “Herman” and/or based on the presence of a contact term “email”.

In FIG. 5, information 508A1 includes information from the alias node of contact entry 156A1 (“Bob Herman), an image associated with an image node (not illustrated in FIG. 2A) of the contact entry 156A1, information from the email node of contact entry 156A1, and a selectable link to view more contact information of contact entry 156A1. In some implementations, the contact identification system 140 and/or the search system 102 may select the information from the email node of contact entry 156A1 for display based on the query “Bob Herman's Email”. For example, the reformulated query provided by the query processing engine 130 may indicate that the query is seeking e-mail information. Based on such indication, the contact identification system 140 may select information from the email node of contact entry 156A1 for providing with the information 508A1.

The information 508B includes a selectable link to see web search results that may include search results for publicly accessible documents. In some implementations, the ranking engine 110 may determine publicly accessible documents related to information 508B are responsive to the query “Bob Herman's Email” based on, for example, matching of one or more terms of the email to information for those publicly accessible documents in the index 125. The ranking engine 110 may determine a score for each of the identified publicly accessible documents and/or a cumulative score for the publicly accessible documents based on one or more signals described herein. For example, the ranking engine 110 may determine scores for the identified publicly accessible documents that are relatively low based on, for example, relatively low popularity of the documents, the contact indication measure for the query “Bob Herman's Email”, etc. The ranking engine 110 may determine to provide the selectable link as information 508B in lieu of more detailed search results based on the relatively low scores for the identified publicly accessible documents and based on the relatively high score for the contact entry 156A1. In some implementations, the ranking engine 110 may determine to provide the information 508A1 and omit the information 508B or any other information related to the web search results based on the relatively low scores for the identified publicly accessible documents and based on the relatively high score for the contact entry 156A1.

FIG. 6 illustrates an example of a user interface for displaying, in response to a query, information related to additional information items. In this example, the user has entered the query “Bob Rolling Stone” into a search field 604 and search results are displayed that are responsive to the query. The search results include information 608B related to publicly accessible documents (e.g., identified from index 125) and omit any information related to contact entries of a user.

In some implementations, the contact identification system 140 may determine one or more contact entries are responsive to the query “Bob Rolling Stone” based on, for example, matching of the term “Bob” to information in the alias node of the contact entries 156A1 and 156B2. The scoring engine 142 may determine a score for the contact entries 156A1 and 156B2 based on one or more signals described herein. For example, the scores for the contact entries 156A1 and 156B2 in the example of FIG. 6 may be lower than the scores for those contact entries in the example of FIG. 4 based on one or more factors. For example, in the example of FIG. 6 there is a match between only one term (“Bob”) out of three terms of the query and a node of the contact entries 156A1 and 156B1, whereas in the example of FIG. 4 all terms of the query matched a node of the contact entries 156As and 156B1. Also, for example, in the example of FIG. 6 the contact indication measure for the query “Bob Rolling Stone” may be less indicative of likelihood contact information is being sought than the contact indication measure for the query of FIG. 4 based on, for example, the presence of additional terms “rolling” and “stone” that are unrelated to contact information being sought.

The information 608B includes search results each including a title of, URL of, and snippet from a publicly accessible document. In some implementations, the ranking engine may determine the publicly accessible documents related to information 608B are responsive to the query “Bob Rolling Stone” based on, for example, matching of the terms of the query to information for those publicly accessible documents in the index 125. The ranking engine 110 may determine a score for each of the identified publicly accessible documents and/or a cumulative score for the publicly accessible documents based on one or more signals described herein. The ranking engine 110 may rank the publicly accessible documents to determine a presentation order of the information 608B.

The ranking engine 110 may further determine to provide the information 608B and omit any information related to the contact entries 156A1 or 156B1 based on one or both of the scores of the contact entries 156A1 and 156B1 and/or based on the scores of the publicly accessible documents. For example, the ranking engine 110 may determine to provide the information 608B and omit information related to the contact entries 156A1 or 156B1 based on the relatively low scores for the identified contact entries and based on the relatively high score for the publicly accessible documents. In some implementations, the ranking engine 110 may determine the publicly accessible documents related to information 608B only when the scores of the contact entries 156A1 and 156B1 fail to satisfy a threshold.

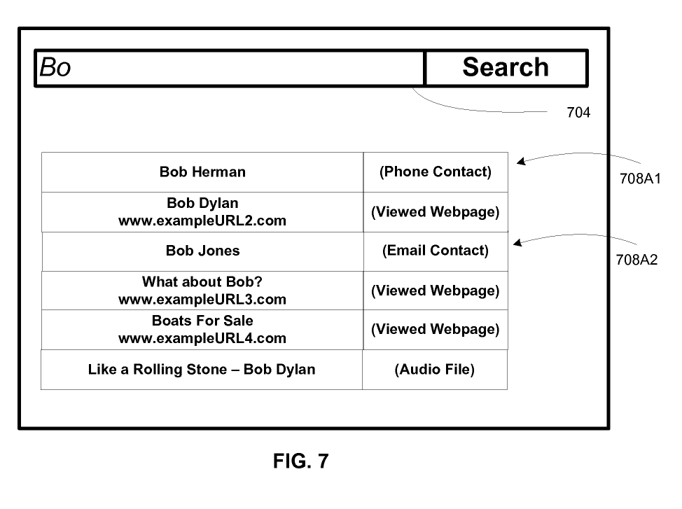

FIG. 7 illustrates another example of a user interface for displaying, in response to a query, information related to contact entries of a user and information related to additional information items. In this example, the user has entered the query “Bo” into a search field 704 and search results are displayed that are responsive to the query. The search results include information 708A1 related to contact entry 156A1 (FIG. 2A), information 708A2 related to the contact entry 156B2 (FIG. 2B), and other information related to non-publicly accessible information items of the user from another source. For example, the information includes information related to webpages viewed by the user (indicated by “(Viewed Webpage)”) and an audio file of the user (indicated by “(Audio File)”).

In some implementations, the contact identification system 140 may determine the contact entries 156A1 and 156B2 are responsive to the query “Bo” based on, for example, matching of the term “Bo” to information in the alias nodes of the contact entries 156A1 and 156B2. The scoring engine 142 may determine a score for each of the contact entries 156A1 and 156B2 based on one or more signals described herein. The ranking engine 110 may determine to provide the contact entry 156A1 more prominently than the contact entry 156B1 based on their scores. For example, the information provided by the search system 102 to enable display of the interface of FIG. 7 may include information indicating the information related to contact entry 156A1 is to be displayed in a more prominent position than the information related to the contact entry 156B1 as illustrated in FIG. 7.

In some implementations, the ranking engine 110 may determine information related to non-publicly accessible information items of the user from another source are responsive to the query “Bo” based on, for example, matching of the term “Bo” to those information items in the index 125 or other source. The ranking engine 110 may determine a score for each of the non-publicly accessible information items of the user from another source based on one or more signals described herein. For example, the score for each of the non-publicly accessible information items of the user from another source may be based on recency, frequency, and/or length of user interaction with those information items. The ranking engine 110 may rank the non-publicly accessible information items and the contact entries to determine a presentation order. For example, the ranking engine 110 may determine the contact entry 156A1 is the highest ranked item based on the scores, followed by the information item related to browsing history of “www.exampleURL2.com”, and so forth.

Although examples in FIGS. 4-7 describe a query that includes an alias of a contact entry, it is understood that contact entries may also be identified based on queries that include terms that match information in other nodes of the contact entries. For example, contact identification system 140 may identify contact entries 156A1 and 156B1 as responsive to a query of “Company A” based on “Company A” matching the organization nodes of those contact entries.

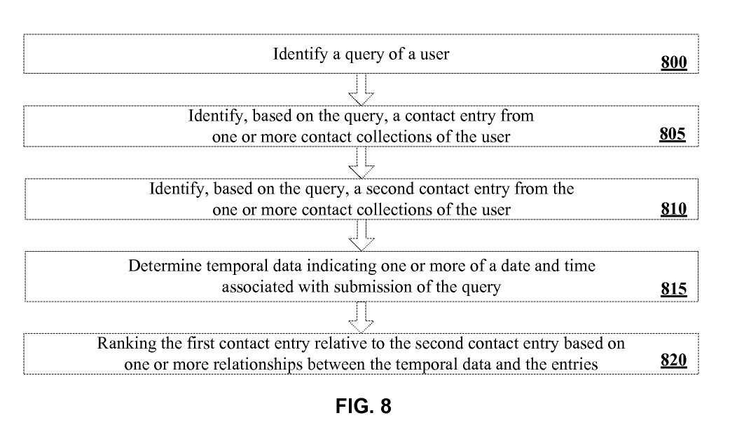

FIG. 8 is a flow chart illustrating an example method of ranking a contact entry of a user relative to another contact entry of the user based on temporal data associated with submission of a query. Other implementations may perform the steps in a different order, omit certain steps, and/or perform different and/or additional steps than those illustrated in FIG. 8. For convenience, aspects of FIG. 8 will be described with reference to a system of one or more computers that perform the process. The system may include, for example, the contact identification system 140 and/or the search system 102 of FIG. 1.

At step 800, a query of a user is identified. For example, the search system 102 may receive a query that is provided via client device 106 in a text form and/or in other form. In some implementations, step 800 and step 300 of FIG. 3 may share one or more aspects in common.

At step 805, a first contact entry is identified from one or more contact collections of the user based on the query. For example, the contact identification system 140 may use one of the contacts collections 156A-C to identify a first contact entry responsive to the query 104. In some implementations, step 805 and step 305 of FIG. 3 may share one or more aspects in common.

At step 810, a second contact entry is identified from the one or more contact collections of the user based on the query. For example, the contact identification system 140 may use one of the contacts collections 156A-C to identify a second contact entry responsive to the query 104. In some implementations, step 810, step 805, and/or step 305 of FIG. 3 may share one or more aspects in common.

At step 815, temporal data indicating one or more of a date and time associated with the submission of the query of step 800 is determined. For example, the search system 102 may determine a date and/or time at which the query was received from the client device 106. The determined date and/or time may be defined in numerous ways. For example, the date may be a day of the week, a month, a particular day or week of a year, etc. Also, for example, the time may be a particular time and/or a range of times such as 8:00-9:00, morning, evening, early morning, late morning, AM, PM, etc.

At step 820, the first contact entry is ranked relative to the second contact entry based on one or more relationships between the temporal data and the first and second contact entries. For example, one or both of the contact entries may include or be associated with temporal data. The temporal data of a contact entry may include indications of one or more times and/or one or more dates associated with the contact entry that indicate time(s) and/or date(s) during which the user has interacted with the entity of the contact entry. The temporal data may be defined in numerous ways. For example, date(s) indicated by temporal data may be a day of the week, a month, a particular day or week of a year (e.g., a holiday, tax day), a date range, etc. Also, for example, time(s) indicated by temporal data may be a particular time and/or a range of times such as 8:00-9:00, morning, evening, early morning, late morning, AM, PM, around noon, etc.

In some implementations, the scoring engine 142 may promote the score of a given contact entry if the given contact entry is associated with temporal data that matches a time and/or date of submission of the query. In some implementations, the scoring engine 142 may additionally and/or alternatively demote the score of a given contact entry if the given contact entry is associated with temporal data that does not match or is not near a time and/or date of submission of the query. Soft matching and/or exact matching may be utilized. In some implementations, the degree of promotion and/or demotion of the score for a contact entry may be based on proximity between the temporal data of the query and the temporal data of the contact entry and/or a weight associated with the matching or near temporal data for the contact entry.

In some implementations, the temporal data of a contact entry may include a type of contact associated with one or more of the times and/or dates that indicates the manner by which the user has interacted with the contact entry (e.g., “calling”, “texting”, “emailing”). In some versions of those implementations, the ranking of the contact entry may further be based on the type of contact. For example, the ranking of a given contact entry may be promoted if the given contact entry is associated with temporal data that matches a time and/or date of submission of the query—and the temporal data is associated with a contact type that matches a contact type indicated by the query identified at step 800.

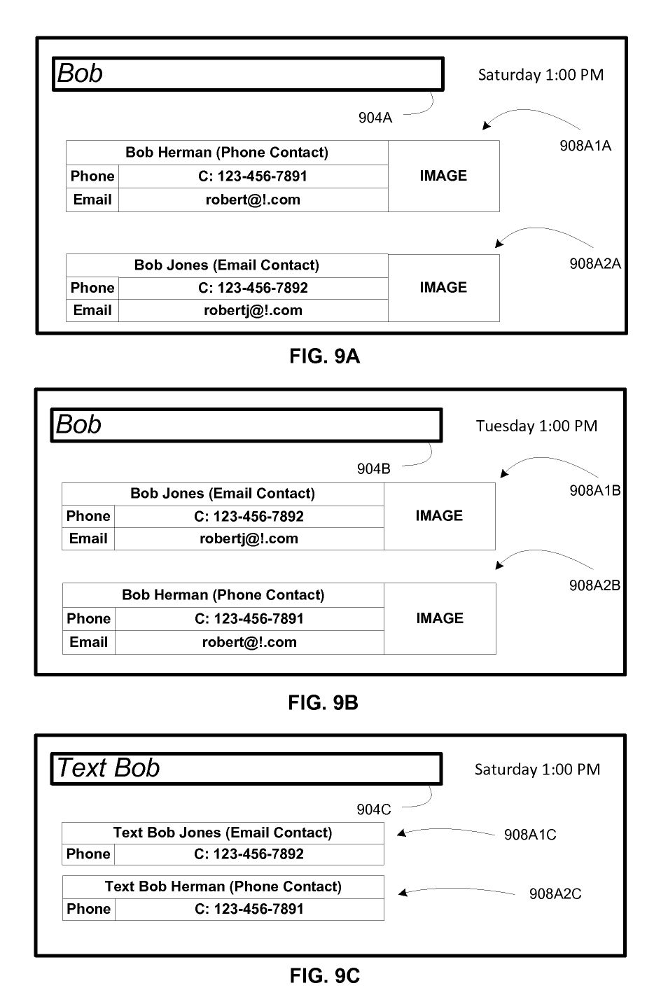

In some implementations, the scoring engine 142 calculates the scores for the contact entries based on one or more additional ranking signals such as those described herein. The ranking engine 110 may rank the contact entries relative to one another based on the scores as described herein. Additional description of ranking a contact entry of a user relative to another contact entry of the user based on temporal data associated with submission of a query is provided below with respect to FIGS. 9A-9C.

FIGS. 9A-9C illustrate examples of a user interface for displaying, in response to a query, information related to contact entries of a user. Each of the user interfaces includes a search field 904A, 904B, 904C. In the examples of FIGS. 9A and 9B, the user has entered the query “Bob” into the search field 904A/B and search results are displayed that are responsive to the query and include information related to contact entry 156A1 (information 908A1A in FIG. 9A; information 908A2B in FIG. 9B) and information related to the contact entry 156B2 (information 908A2A in FIG. 9A; information 908A1B in FIG. 9B). In the example of FIG. 9A the information 908A1A related to contact entry 156A1 is displayed above the information 908A2A related to contact entry 156B2. However, in the example of FIG. 9B the information 908A1B related to contact entry 156B2 is displayed above the information 908A2B related to contact entry 156A1. This difference in display is based on different rankings of the contact entries based on different temporal data being associated with submission of the queries in FIGS. 9A and 9B.

In FIG. 9A, the query is submitted on a Saturday at 1:00 PM, whereas in FIG. 9B the query is submitted on a Tuesday at 1:00 PM. As illustrated in FIG. 2A, temporal data node of contact entry 156A1 includes information that indicates weekend calls with a value of 0.8, weekend e-mails with a value of 0.2, and weekday e-mails with a value of 0.2. As illustrated in FIG. 2B, temporal data node of contact entry 156B2 includes information that indicates weekday texts with a value of 0.8, weekend texts with a value of 0.6, and weekday calls with a value of 0.2. In the example of FIGS. 2A and 2B, the values generally indicate a weighting from 0 to 1 with larger values indicating a greater propensity of the user to interact with the contact via the indicated manner. For example, based on the values of contact entry 156A1 the user has a greater propensity to call “Bob Herman” on the weekend than to email “Bob Herman” on the weekend. In some implementations, the values may be based on past interactions of the user with the contact entry as indicated, for example, by the client device 106.

Based at least in part on the temporal data of the contact entry 156A1 and the queries of FIGS. 9A and 9B, the scoring engine 142 may determine a score for the contact entry 156A1 based on the query of FIG. 9A (submitted on Saturday at 1:00 PM) that is greater than a score determined for the contact entry 156A1 based on the query of FIG. 9B (submitted on Tuesday at 1:00 PM). Likewise, based at least in part on the temporal data of the contact entry 156B2 and the queries of FIGS. 9A and 9B, the scoring engine 142 may determine a score for the contact entry 156B2 based on the query of FIG. 9A (submitted on Saturday at 1:00 PM) that is less than a score determined for the contact entry 156B2 based on the query of FIG. 9B (submitted on Tuesday at 1:00 PM). Based on these differences in scores, the contact entries may be ranked differently as indicated by the displays of FIGS. 9A and 9B.

In the examples of FIG. 9C, the user has entered the query “Text Bob” into the search field 904C and search results are displayed that are responsive to the query and include information 908A1C related to contact entry 156A1 and information 908A2C related to the contact entry 156B2. In the example of FIG. 9C the query is submitted on a Saturday at 1:00 PM as is the query of the example of FIG. 9A. However, in the example of FIG. 9C the information 908A1C related to contact entry 156A1 is displayed below the information 908A2C related to contact entry 156B2. This difference in display is based on different rankings of the contact entries based on the presence of “text” in the query of FIG. 9C. Based on the query of FIG. 9C indicating a desire to “text” Bob (e.g., as indicated by a reformulated query of query processing engine 130), a subset of the temporal data of the temporal nodes of contact entries 156A1 and 156B1 may be utilized and/or weighted more heavily in the scoring of those contact entries. For example, in some implementations the score of the contact entry 156B2 may be increased relative to the example of FIG. 9A based on the contact entry 156B2 including temporal data associated with weekend texts and/or based on the contact entry 156B2 including temporal data associated with weekday texts, whereas the contact entry 156B1 does not include any temporal data related to texts. Based on increase in scoring relative to the example of FIG. 9A, the ranking of the contact entry 156B2 may be increased relative to its ranking in the example of FIG. 9A, as indicated by the display of FIG. 9C.

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

FIG. 10 is a block diagram of an example computer system 1010. Computer system 1010 typically includes at least one processor 1014 which communicates with a number of peripheral devices via bus subsystem 1012. These peripheral devices may include a storage subsystem 1024, including, for example, a memory subsystem 1025 and a file storage subsystem 1027, user interface input devices 1022, user interface output devices 1020, and a network interface subsystem 1016. The input and output devices allow user interaction with computer system 1010. Network interface subsystem 1016 provides an interface to outside networks and is coupled to corresponding interface devices in other computer systems.

User interface input devices 1022 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 1010 or onto a communication network.

User interface output devices 1020 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 1010 to the user or to another machine or computer system.

Storage subsystem 1024 stores programming and data constructs that provide the functionality of some or all of the modules described herein. For example, the storage subsystem 1024 may include the logic to perform one or more of the methods described herein such as, for example, the methods of FIGS. 3 and/or 8.

These software modules are generally executed by processor 1014 alone or in combination with other processors. Memory 1025 used in the storage subsystem can include a number of memories including a main random access memory (RAM) 1030 for storage of instructions and data during program execution and a read only memory (ROM) 1032 in which fixed instructions are stored. A file storage subsystem 1027 can provide persistent storage for program and data files, and may include a hard disk drive, a floppy disk drive along with associated removable media, a CD-ROM drive, an optical drive, or removable media cartridges. The modules implementing the functionality of certain implementations may be stored by storage subsystem 1024 in the file storage subsystem 1027, or in other machines accessible by the processor(s) 1014.

Bus subsystem 1012 provides a mechanism for letting the various components and subsystems of computer system 1010 communicate with each other as intended. Although bus subsystem 1012 is shown schematically as a single bus, alternative implementations of the bus subsystem may use multiple busses.

Computer system 1010 can be of varying types including a workstation, server, computing cluster, blade server, server farm, or any other data processing system or computing device. Due to the ever-changing nature of computers and networks, the description of computer system 1010 depicted in FIG. 10 is intended only as a specific example for purposes of illustrating some implementations. Many other configurations of computer system 1010 are possible having more or fewer components than the computer system depicted in FIG. 10.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A computer-implemented method, comprising:
identifying a query of a user, the query submitted via a user device;
identifying a contact indication measure of the query, the contact indication measure indicative of likelihood the query seeks contact information, wherein the contact indication measure is determined based on which of multiple interfaces, accessible via the user device, is utilized by the user in submitting the query;
identifying, from a contacts collection personal to the user, a contact entry of the contacts collection based on one or more relationships between the query and the contact entry;
determining a contact entry score for the contact entry based at least in part on the one or more relationships between the query and the contact entry and based on the contact indication measure of the query;
identifying, from a source distinct from the contacts collection, at least one additional information item based on one or more relationships between the query and the additional information item, the additional information item being a non-contact entry information item;
determining an additional information item score for the additional information item based at least in part on the one or more relationships between the query and the additional information item, wherein the additional information item score is distinct from the contact entry score;
ranking the contact entry and the additional information item based on the contact entry score and the additional information item score; and
providing, based on the ranking and responsive to the query:
contact information related to the contact entry, and
additional information related to the additional information item, the additional information provided as a result for presentation separate from the contact information.

2. The computer-implemented method of claim 1, wherein the source distinct from the contacts collection is an index of publicly accessible information items.

3. The computer-implemented method of claim 2, further comprising:
determining the contact entry score fails to satisfy a threshold;
wherein identifying the at least one additional information item occurs in response to the contact entry score failing to satisfy a threshold.

4. The computer-implemented method of claim 1, wherein determining the contact entry score includes determining the contact entry score based on an affinity measure associated with the contacts collection.

5. (canceled)

6. The computer-implemented method of claim 1, wherein determining the contact entry score for the contact entry based at least in part on the one or more relationships between the query and the contact entry includes:
identifying a matching relationship between a term of the query and a node of the contact entry; and
determining the contact entry score based on a node type of the node.

7. (canceled)

8. The computer-implemented method of claim 1, wherein the contact indication measure of the query is further based at least in part on one or more terms of the query.

9. The computer-implemented method of claim 1, wherein determining the contact entry score for the contact entry based at least in part on the one or more relationships between the query and the contact entry includes:
identifying a lack of matching between a term of the query and the contact entry, wherein the contact entry score is based on a type of the term of the query.

10. The computer-implemented method of claim 1, wherein determining the contact entry score for the contact entry based at least in part on the one or more relationships between the query and the contact entry includes:
identifying one or more of a date and a time associated with a submission of the query; and
determining the contact entry score based on an association between the one or more of the date and time and the contact entry.

11. (canceled)

12. The computer-implemented method of claim 1, wherein providing the contact information related to the contact entry and the additional information related to the additional information item includes:
providing the contact information related to the contact entry with a prominence that is based on the ranking.

13. A computer-implemented method, comprising:
identifying a query of a user;
identifying, from one or more contacts collections associated with the user, a first contact entry based on one or more relationships between the query and the first contact entry;
identifying first contact entry temporal data of the first contact entry, the first contact entry temporal data indicating at least one first temporal characteristic of multiple past interactions of the user with a first contact of the first contact entry;
identifying, from the one or more contacts collections, a second contact entry based on one or more relationships between the query and the second contact entry;
identifying second contact entry temporal data of the second contact entry, the second contact entry temporal data indicating at least one second temporal characteristic of multiple past interactions of the user with a second contact of the second contact entry;
determining query temporal data, the query temporal data indicating one or more of a date and a time associated with submission of the query;
ranking the first contact entry relative to the second contact entry based on one or more relationships between the query temporal data and: the first temporal data of the first contact entry, and the second temporal data of the second contact entry; and
providing, for presentation in response to the query, information related to both the first contact entry and the second contact entry;
wherein prominence of the first contact entry and the second contact entry in the provided information is based on the ranking.

14-15. (canceled)

16. A system including memory and one or more processor s operable to execute instructions stored in the memory, comprising instructions to:
identify a query of a user, the query submitted via a user device;
identify a contact indication measure of the query, the contact indication measure indicative of likelihood the query seeks contact information, wherein the contact indication measure is determined based on which of multiple interfaces, accessible via the user device, is utilized by the user in submitting the query;
identify, from a contacts collection personal to the user, a contact entry of the contacts collection based on one or more relationships between the query and the contact entry and based on the contact indication measure of the query;
determine a contact entry score for the contact entry based at least in part on the one or more relationships between the query and the contact entry;
identify, from a source distinct from the contacts collection, at least one additional information item based on one or more relationships between the query and the additional information item, the additional information item being a non-contact entry information item;
determine an additional information item score for the additional information item based at least in part on the one or more relationships between the query and the additional information item, wherein the additional information item score is distinct from the contact entry score;
rank the contact entry and the additional information item based on the contact entry score and the additional information item score; and
provide, based on the ranking and responsive to the query:
contact information related to the contact entry, and
additional information related to the additional information item, the additional information provided as a result for presentation separate from the contact information.

17. The system of claim 16, wherein the source distinct from the contacts collection is an index of publicly accessible information items.

18. The system of claim 17, wherein the instructions further include instructions to determine the contact entry score fails to satisfy a threshold, wherein the instructions to identify the at least one additional information item include instruction to identify the at least one additional information item in response to the contact entry score failing to satisfy a threshold.

19. The system of claim 16, wherein the instructions to determine the contact entry score include instructions to determine the contact entry score based on an affinity measure associated with the contacts collection.

20. (canceled)

21. The system of claim 16, wherein the instructions to determine the contact entry score for the contact entry based at least in part on the one or more relationships between the query and the contact entry include instructions to:
identify a matching relationship between a term of the query and a node of the contact entry; and
determine the contact entry score based on a node type of the node.

22. (canceled)

23. The system of claim 16, wherein the contact indication measure of the query is further based at least in part on one or more terms of the query.

24. The system of claim 16, wherein the instructions to determine the contact entry score for the contact entry based at least in part on the one or more relationships between the query and the contact entry include instructions to:
identify a lack of matching between a term of the query and the contact entry, wherein the contact entry score is based on a type of the term of the query.

25. The system of claim 16, wherein the instructions to determine the contact entry score for the contact entry based at least in part on the one or more relationships between the query and the contact entry include instructions to:
identify one or more of a date and a time associated with a submission of the query; and
determine the contact entry score based on an association between the one or more of the date and time and the contact entry.

26. (canceled)

27. The system of claim 16, wherein the instructions to provide the contact information related to the contact entry and the additional information related to the additional information item include instructions to:
provide the contact information related to the contact entry with a prominence that is based on the ranking.

28. A non-transitory computer readable storage medium storing computer instructions executable by a processor to perform a method comprising:
identifying a query of a user, the query submitted via a user device;
identifying a contact indication measure of the query, the contact indication measure indicative of likelihood the query seeks contact information, wherein the contact indication measure is determined based on which of multiple interfaces, accessible via the user device, is utilized by the user in submitting the query;
identifying, from a contacts collection personal to the user, a contact entry of the contacts collection based on one or more relationships between the query and the contact entry;
determining a contact entry score for the contact entry based at least in part on the one or more relationships between the query and the contact entry and based on the contact indication measure of the query;
identifying, from a source distinct from the contacts collection, at least one additional information item based on one or more relationships between the query and the additional information item, the additional information item being a non-contact entry information item;
determining an additional information item score for the additional information item based at least in part on the one or more relationships between the query and the additional information item, wherein the additional information item score is distinct from the contact entry score;
ranking the contact entry and the additional information item based on the contact entry score and the additional information item score; and
providing, based on the ranking and responsive to the query
contact information related to the contact entry, and
additional information related to the additional information item, the additional information provided as a result for presentation separate from the contact information.

29. The method of claim 1, wherein determining the additional information item score for the additional information item is further based on one or more ranking signals that are in addition to those utilized in determining the contact entry score for the contact entry.

30. The method of claim 29, wherein the one or more ranking signals that are in addition to those utilized in determining the contact entry score for the contact entry include popularity among a population of multiple users.

31. (canceled)

32. The method of claim 13, wherein the first temporal characteristic indicates at least one particular day of a week of the multiple past interactions of the user with the first contact, and wherein ranking the first contact entry relative to the second contact entry is based on the query temporal data and the first temporal characteristic both indicating the particular day of the week.

33. The method of claim 13, wherein the first temporal characteristic indicates a time range of the multiple past interactions of the user with the first contact, and wherein ranking the first contact entry relative to the second contact entry is based on the query temporal data and the second temporal characteristic both indicating the particular time range.

34. The method of claim 13, wherein the first temporal data is associated with a first weight, wherein the second temporal data is associated with a second weight, and wherein ranking the first contact entry relative to the second contact entry is further based on the first weight and the second weight.
